(19) United States
(12) Patent Application Publication
(10) Pub. No.: US 2012/0200075 A1
(43) Pub. Date: Aug. 9, 2012

(54) Mirrored Practice Notebook

(76) Inventor: Rita Coore-Widener, Spring, TX (US)

(21) Appl. No.: 13/021,338

(22) Filed: Feb. 4, 2011

(51) Int. Cl. B42D 3/00

(52) U.S. Cl. 281/29

(57) ABSTRACT

The invention describes a portfolio, presentation folder, music folder or the like including one or more mirrors to permit the user to practice playing a musical instrument, singing or delivering other oral presentation while observing the mirror(s). The mirrored portfolio provides a folio with front and back covers attached together by a spine. One or more mirrors are positioned on the insides of the front or back covers in either a removably attached, hingedly attached or fixedly attached manner. In one embodiment, a primary mirror is attached to the inside of the back cover in a fixed position while a secondary mirror is positioned on the inside face of the front cover in hinged manner at its outer edge to permit it to swing outwardly from the folio to a desired angle. The folio may include one or more internal or external pockets for holding music, papers and the like.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

1. Field of Use

The present disclosure is generally directed to practice mirrors used to assist a musician in practicing technique or to assist a person in preparing for a presentation or other type of speech. More specifically, the current disclosure is directed to mirrored practice notebooks that can be placed on a music stand, podium or other surface.

2. Background Technology

U.S. Pat. No. 4,934,584 (Jun. 19, 1990, Wyant), discloses a portfolio or binder comprising a front cover having a cut-out section, a rear cover hingedly connected to the front cover, and a flexible sheet having a reflective surface, the sheet being attached to the front cover such that the reflective surface is displayed outwardly through the cut-out section to define a mirror. The portfolio or binder also comprises short inner pocket panels. The portfolio, with its mirrorized cover, permits students to monitor their personal appearance during the school day without having to carry a separate hand mirror.

U.S. Pat. No. 4,637,631 (Jan. 20, 1987, Baer) and U.S. Pat. No. 4,743,047 (May 10, 1988, Baer) , which is a continuation-in-part of Baer U.S. Pat. No. 4,637,631, together disclose a book in combination with a mirror. A book such as one might ordinarily keep on one's shelf has a mirror embedded in one of the bound sections such that upon picking up the book and leafing through several pages, one is confronted with one's reflection. This allows for an added dimension to communication. The mirror is embedded in a thick section, the leaves of which may be bound and laminated together, a hole corresponding in dimensions to the mirror is cut partially therethrough, a mirror is immovably placed in said hole. In one embodiment, the mirror is mounted in countersunk fashion in the back cover with mounting means. In another embodiment, a reflective surface of the mirror is flush with the inner surface of the cover. In another embodiment, the mirror is embedded into a rather thick page wherein is embedded a mirror that would reflect the reader's face when the reader opens the book to that page thereby serving as a means for conveying nonverbal communication within a verbal communication media. The identity of the reader (via the mirrored reflection of the reader's face) may be intended to coincide with the identity of a person to whom the book is dedicated.

U.S. Pat. No. 1,804,487 (May 12, 1931, Yoshioka) discloses a mirror removably mounted on the inner surface of the cover of a book to serve as an agent through means of which one's personal appearance may be indicated. The mirror may be readily removed from place for the purposes of replacement or substitution.

U.S. Pat. No. 6,851,825 (Feb. 8, 2005, Marshall) discloses an attachable book mirror device that enables the reader of a textual document to view the facial expressions of the young adult, child, toddler, or baby who is listening in close proximity to the reader. The listener can also view the mechanical lip movements of the reader to thereby shorten process of learning to read. The attachable book mirror includes a shell for housing the optically human visual spectrum reflective material that is pivotally connected to a base used to attach to the covers of books or any other suitable document. The reflective material can be adjusted in any allowable position, holding its last position due to certain equal but opposite forces that are generated by certain internal components such as a spring contained within the base that helps create a lasting static contact frictional force. An adjustable light may be pivotally attached to the book mirror.

U.S. Pat. No. 6,962,421 (Nov. 8, 2005, Yang) discloses a folding full length mirror and carry apparatus that includes a foldable reflective surface support assembly which includes support panels connected together with panel interconnection hinges. A non-folded reflective surface assembly is supported by the foldable reflective surface support assembly. Preferably, a handle is connected to the foldable reflective surface support assembly. A shoulder strap can be connected to the foldable reflective surface support assembly. Preferably, a folded condition locking assembly is connected to the foldable reflective surface support assembly for retaining the apparatus in a folded up, carrying condition. With one embodiment of the invention, the non-folded reflective surface assembly includes panel mounted non-folded reflective surfaces mounted one side of each of the respective support panels. With another embodiment of the invention, the reflective surface assembly includes a reflective rollable non-folded sheet wound on a roller assembly supported by the foldable reflective surface support assembly.

U.S. Pat. No. 5,174,576 (Dec. 29, 1992, Lee et al) discloses a portable mirror apparatus for a golfer to view his swing which has a U-shaped hollow tubular frame with cross in between, also divided in the middle and a mirror attached on the front. A pair of retracting legs support the invention in the vertical position each having a support bar for stiffening. The invention folds in the middle for transportation and storage with the legs pivoted inward contiguous with the frame. The mirror contains marks in the form of lines both horizontal and vertical to indicate proper alignment of the golfer during the swing of a golf club. The mirror is thermoplastic for strength and durability, also to reduce weight. The mirror is constructed of a sturdy and durable thermoplastic material, such as acrylic, that may be transported and set up without the fear of breakage and the dangers involved with conventional glass mirrors.

Similarly, U.S. Pat. No. 5,270,871 (Dec. 14, 1993, Florian) provides for an athletic skill practice mirror which is light weight and relatively portable. The mirror can have an alignment image whereby a participant can stand in front of the practice mirror and compare his reflective image with that of the alignment image to detect and correct improper body alignment.

U.S. D407,452 (Mar. 30, 1999, Porter) provides an ornamental design for a golf putter head with a removable practice mirror.

U.S. Pat. No. 6,626,675 (Sep. 30, 2003, Webber) discloses a multiple activity apparatus is for educational, therapeutic, or recreational use comprising three rectangular frame members joined at abutting ends in a triangular configuration having open triangular ends. The triangular configuration has a base and upwardly converging sides with a utility board mounted in each respective frame member. Each board has an exterior work surface so that a pair of upright work surfaces are selectively positionable for use at any one time. A method of utilizing visual teaching aids comprises the steps of assembling three utility panels each having a side surface useful as a teaching aid; disconnectably joining each of the three panels in juxtaposition forming at least two junctures between panels with the exterior surfaces positioned at an angle for use as teaching aids; and stacking the three boards generally fiat forming an assembly for transport. The exterior surfaces may include a mirror, a wipe on-off dual function and magnetic board, and a pocket board. The mirror activity panel is used so that the student may watch the muscle movements of the articular muscles of his mouth. By watching the muscle movements of the mouth, the student can see how the mouth is shaped in order to pronounce the correct sounds. In this manner, by practice, the student can learn proper articulation of sounds and words.

U.S. Pat. No. 6,267,413 (Jul. 31, 2001, Tran) discloses a double album of photograph display that includes two mirror image portions located on opposite sides of a central web. Each mirror image portion is formed with a stiff, rectangular outer cover panel, an intermediate end panel, and a stiff inner cover panel. A packet of photograph mounting sheets is secured to the inside surface of the end panel of each mirror image portion of the base structure. Each of the photograph mounting sheets is capable of mounting at least one photograph. Preferably, pockets are provided in each photograph mounting sheet to accommodate a plurality of photographs in each mounting sheet. Photograph viewing windows are formed through the inner cover panels. Mutually engageable fasteners, such as spring ties, on each side of the central web may be provided to hold each packet within the confines of its associated outer and inner cover panel and the end panel to which the packet is secured. The album may be used as a freestanding structure whereby photographs in the viewing windows of the inner cover panels are displayed much in the manner of a freestanding frame for a plurality of photographs. When the fasteners are disengaged, the photograph mounting pages within both packets are accessible for viewing concurrently. The album may also be completely folded into a compact, generally rectangular book-like structure and stored in a book case, if desired.

U.S. Pat. No. 0,470,861 (Mar. 15, 1892, Chichester) discloses a book having a double-sided slate surface removably mounted on the inside of one or both of the book's covers. The slate is preferably of flexible material, such as paper, with one or both surfaces covered with a silicate slate or similar preparation that produces a surface adapted to the reception of pencil marks. The slate is removable for cleaning.

US2009/0140511 (Jun. 4, 2009, Pestl) discloses an album for photographs and similar collectable items that comprises a set of one or more straps extending from the album and arranged to either wrap around the edges of the album to hold it closed, or to provide stability to the album when it is opened in an easel configuration for display of the album contents.

U.S. Pat. No. 4,703,952 (Nov. 3, 1987, Biasini) discloses a folder of the type used for carrying sheets of material and being adaptable for displaying the sheets, being provided with a folder having a pair of panels joining together and being foldable at a center of the folder. Each panel has a pocket portion for storing the sheets of material and a foldable ledge means for displaying the sheets when the folder is in an open position. The folder is also provided with bands for supporting the folder on the hand of a user and means for displaying the folder in an open position on substantially flat surfaces.

U.S. Pat. No. 5,356,109 (Oct. 16, 1994, Biasini) discloses a music stand extender adapted to be mounted to a conventional music stand in a manner to present an expanded support area. This extender comprises, in a preferred form, three panel sections which in an expanded position rest against a back portion of the music stand, and three flange sections that are positioned on a lower ledge portion of the stand. The extender can be folded over on itself to function as a sheet music container and carrier, and can be extended to its support position to be placed on a music stand. In one embodiment there is provided a strap which extends along the upper back portion of the panel sections for use in securing the extender to the music stand. In another embodiment, a retaining sheet or pocket section extends along the back top edge of the extender capable of being slipped over the top of the music stand sheet support section to secure the extender to the music stand.

US2005/0012014 (Jan. 20, 2005, Willner et al) discloses a music-stand-fitting removable sleeve or clipped-on device that fits over a music stand, of the type used to display sheet music for a musician, which performs the purpose of holding music, books, papers, or writing implements via additional securing devices and pockets. The Sheet Music Stand Helper is a removable sleeve or clipped-on device which fits over the top of a music stand, which has one or more pockets in the back for holding sheet music and/or writing implements, transparent pockets in the front, for holding viewable sheet music, and a vertical strap in the middle to secure music to the Sheet Music Stand Helper, with fabric under the strap to muffle snapping sound should the securing strap be snapped.

U.S. Pat. No. 4,512,603 (Apr. 23, 1985, Williams) discloses a book support system that employs an elastic cord to secure the book to the support system.

US2009/0189388 (Jul. 30, 2009, Mills) discloses an adjustable book holder device that employs an elastic band extending from one side to the other to exert a slight pressure on the open book pages to keep the book in the open position while resting on the support plate. A relatively thin cord or strap may be used for the elastic band, and if a strap is used, the strap may be transparent. A flexible chain may be adjusted to alter the inclination of the support plate with respect to a rear brace.

However, there still exists a need to provide a mirrored portfolio, for holding music, notes, and the like, to permit a musician, singer, presenter, etc. to have portable mirrors provided in the same carrying case to provide for an enhanced mode of practicing such music, singing, or presentation.

### SUMMARY OF INVENTION

The invention describes a portfolio, presentation folder, music folder or the like including one or more mirrors to permit the user to practice playing a musical instrument, singing or delivering other oral presentation while observing himself/herself in the mirror(s). The mirrored portfolio provides a folio with front and back covers attached together by a spine. One or more mirrors are positioned on the insides of the front or back covers in either a removably attached, hingedly attached or fixedly attached manner. In one embodiment, a primary mirror is attached to the inside of the back cover in a fixed position while a secondary mirror is positioned on the inside face of the front cover in hinged manner at its outer edge to permit it to swing outwardly from the folio to a desired angle. The folio may include one or more internal or external pockets for holding music, papers and the like.

The present disclosure describes a notebook (which may be padded) having two mirrors (one or both may be hinged). The notebook is to be used as a practice tool for speakers, musicians, etc., and may be attached to a music stand or podium, and may include straps for securing it.

The mirrored portfolio of the present invention includes a conveniently sized, portable mirror for use on any music stand or podium. In one embodiment, the invention is used as a practice tool for student and professional musicians. The invention may also be useful to public speakers as a practice tool. It is suitable for use at home, classroom settings, and discreet enough to be used during performance or live presentation if needed. The design is compact (fitting within a standard music folder, or presentation folio, etc.) and therefore is readily portable and stores easily.

One embodiment of the present invention features a padded notebook. The notebook works as a frame for the mirror and carrying case when folded. In one embodiment, the notebook has the following dimensions when folded: Width 9.25 in.×Length 12.5 in.×Depth 0.75 in. The notebook may be outfitted with hook and loop fasteners, such as the Velcro brand on the outside of the notebook used to secure the two sides of the notebook together when used in a configuration requiring the front and back cover panels to be opened fully in a back to back manner. The notebook ideally employs a large flat mirror to service as the primary reflective surface. In the above-dimensioned notebook, ideal mirror dimensions are: Length 10 in.×Width 8 in. This large, flat mirror is attached to one of the inner covers of the notebook. A second, hinged mirror is the secondary reflective surface and provides an extended view as it may be opened into extended configurations. The mirror angle can be adjusted with the hinge and the mirror folds flat onto the inside cover for storage. One suitable set of dimensions for the secondary mirror is: Length 8 in.×Width 5 in. The hinged mirror is ideally attached to the inside of the other cover, about 0.5 in. from the edge of the notebook and is ideally centered along the length of notebook cover. A protective cloth cover is provided for the large mirror to help prevent scratching during storage. Buttons (or other fasteners) attached to notebook provide anchor for elastic security straps that can be used to keep the notebook in its closed position, or to assist in securing it into an open position on a music stand or podium. The elastic can be used to secure the mirrored notebook to the music stand to help prevent it from falling off during use. Also, the elastic may be used to keep the notebook closed during storage or travel. The elastic attached to the bottom right corner of the inside folder cover is approximately 17.25 in. The elastic attached to the inside at the center of right side of notebook is approximately 10.5 in. Other dimensions are possible. The notebook ideally contains a pocket on the side of the notebook used for storing sheet music or other papers. In use, the notebook can be turned upside down so that the flat mirror can be on the left and the hinged mirror on the right during use. Buttons or other attachment devices can be used to anchor the elastic closures (much like the button/elastic closures used on envelopes and folders. However, the elastic could be attached directly to the cover, e.g., by sewing thereby eliminating the need for buttons.

In one embodiment of the present disclosure there is disclosed and described a A portable mirrored practice notebook comprising: (a) a front cover having a front cover inside face, a front cover outside face, a front cover top edge, a front cover bottom edge opposite the front cover top edge, a front cover outside edge, and a front cover inside edge opposite the front cover outside edge; (b) a back cover having a back cover inside face, a back cover outside face, a back cover top edge, a back cover bottom edge opposite the back cover top edge, a back cover outside edge, and a back cover inside edge opposite the back cover outside edge; (c) a flexible spine hingedly connecting the front cover inside edge to the back cover inside edge to permit the front cover and back cover to open and close about the hinged connection along a desired spine angle; (d) a first mirror attached to the back cover inside face, the first mirror having a front surface, a rear surface, a top edge, a bottom edge opposite the top edge, an inside edge and an outside edge opposite the inside edge; (e) a second mirror attached to the front cover inside face, the second mirror having a front surface, a rear surface, a top edge, a bottom edge opposite the top edge, an inside edge and an outside edge opposite the inside edge, wherein the second mirror inside edge is hingably attached to the front cover inside face proximate the front cover outside edge to permit the second mirror to be adjustably rotated about the hinged attachment between a closed position and an open position, the closed position being defined as where the second mirror front surface rests against the front cover inside face, the open position being defined as where the second mirror front surface is rotated away from the front cover inside face to a desired second mirror angle; and (f) at least one pocket to receive notepapers, sheet music, or the like.

In one embodiment, the front surface of the first mirror contains a reflective mirror finish and the rear surface of the first mirror is mounted to the back cover inside face using glue, adhesives, double sided adhesive tape, clips, fasteners, hook and loop fasteners, magnetic mounts, hinges or the like.

In another embodiment, the first mirror inside edge is hingably attached to the back cover inside face proximate the back cover inside edge to permit the first mirror to be rotated about its hinge. The front surface and/or rear surface of the first mirror contains a reflective mirror finish. In one embodiment, the first mirror outside edge is hingably attached to the back cover inside face proximate the back cover outside edge to permit the first mirror to be rotated about its hinge. In another embodiment, the first mirror top edge is hingably attached to the back cover inside face proximate the back cover top edge to permit the first mirror to be rotated about its hinge.

The back cover inside face may contain a recessed area for receiving the first mirror. The first mirror may cover a substantial portion of the back cover inside face. A flexible protective material may be provided for covering the first mirror, the flexible material being attached to the back cover inside face to permit the protective material to cover the mirror when the mirror is not in use and to be pulled back to expose the mirror when the mirror is to be used. The flexible protective material may be selected from the group consisting of: synthetic cloth, natural cloth, flannel cloth, synthetic and natural cloth blends, soft suede-like material, plastic sheet material, rubber sheet material, and the like.

The second mirror angle may range between about 0° and 180°. The second mirror front surface and/or rear surface contains a reflective mirror finish. The front cover inside face may also include a recessed area for receiving the second mirror when the second mirror is in its closed position.

The notebook might also employ a padded layer between the front cover inside face and the front cover outside face and a padded layer between the back cover inside face and the back cover outside face. The spine angle may be adjustable between about 0° and about 360°. The notebook preferably contains at least one pocket built into the front or back cover inside face. The notebook may also employ one or more closure devices for securing the front cover to the back cover when the spine angle is either about 0° (where the front cover inside face faces the back cover inside face) and 360° (where the front cover outside face faces the back cover outside face). The closure devices may be selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like. The notebook may also further comprise one or more attachment devices for securing the portfolio practice mirror to a stand, the one or more attachment devices being selected from the group consisting of ties, fasteners, hook and loop fasteners, straps, elastic loops, button fasteners, clips and the like.

In another embodiment of the present invention, there is discloses a portable mirrored practice portfolio comprising: (a) a padded front cover having an front cover inside face, a front cover outside face, a front cover top edge, a front cover bottom edge opposite the front cover top edge, a front cover outside edge, and a front cover inside edge opposite the front cover outside edge; (b) a padded back cover having an back cover inside face, a back cover outside face, a back cover top edge, a back cover bottom edge opposite the back cover top edge, a back cover outside edge, and a back cover inside edge opposite the back cover outside edge; (c) a flexible spine hingedly connecting the front cover inside edge to the back cover inside edge to permit the front cover and back cover to open and close about the hinged connection along a desired spine angle; (d) a first mirror fixedly attached to the back cover inside face, the first mirror having a front mirrored finish surface, a rear surface attached to the back cover inside face, a top edge, a bottom edge opposite the top edge, an inside edge and an outside edge opposite the inside edge, wherein the rear surface of the first mirror is attached to the back cover inside face using glue, adhesives, double sided adhesive tape, clips, fasteners, hook and loop fasteners, magnetic mounts, hinges or the like; (e) a second mirror attached to the front cover inside face, the second mirror having a front mirrored finish surface, a rear surface, a top edge, a bottom edge opposite the top edge, an inside edge and an outside edge opposite the inside edge, wherein the second mirror inside edge is hingably attached to the front cover inside face proximate the front cover outside edge to permit the second mirror to be rotated about the hinged attachment between a closed position and an open position, the closed position being defined as where the second mirror front surface rests against the front cover inside face, the open position being defined as where the second mirror front surface is rotated away from the front cover inside face to a desired second mirror angle; (f) a flexible protective material for covering the first mirror, the flexible material having a top edge, bottom edge, right side edge and left side edge, the flexible material being attached to the back cover inside face to permit the protective material to cover the mirror when the mirror is not in use and to be pulled back to expose the mirror when the mirror is to be used, wherein one edge of the flexible protective material is mounted proximate to a corresponding edge of the first mirror, wherein the flexible protective material is selected from the group consisting of: synthetic cloth, natural cloth, synthetic and natural cloth blends, plastic sheet material, rubber sheet material and the like; (g) one or more pockets located within the front cover inside face and/or the back cover inside face capable of receiving notepapers, sheet music, and the like; and (h) one or more elastic loops attachable proximate to the outer edges of the front cover outside edge and/or the back cover outside edge for securing the portfolio into a closed position or to secure the portfolio to a stand upon which the portfolio is placed.

Another embodiment of the present invention describes a portable mirrored practice folio comprising: (a) a front cover having an front cover inside face, a front cover outside face, a front cover top edge, a front cover bottom edge opposite the front cover top edge, a front cover outside edge, and a front cover inside edge opposite the front cover outside edge; (b) a back cover having an back cover inside face, a back cover outside face, a back cover top edge, a back cover bottom edge opposite the back cover top edge, a back cover outside edge, and a back cover inside edge opposite the back cover outside edge; (c) a flexible spine hingedly connecting the front cover inside edge to the back cover inside edge to permit the front cover and back cover to open and close about the hinged connection along a desired spine angle; (d) a primary mirror fixedly attached to the back cover inside face, the primary mirror having a front mirrored finish surface, a rear surface, a top edge, a bottom edge opposite the top edge, an inside edge and an outside edge opposite the inside edge, wherein the primary mirror inside edge is hingably attached to the back cover inside face proximate the back cover inside edge to permit the primary mirror to be rotated about its hinge; (e) a secondary mirror attached to the front cover inside face, the secondary mirror having a front mirrored finish surface, a rear surface, a top edge, a bottom edge opposite the top edge, an inside edge and an outside edge opposite the inside edge, wherein the second mirror inside edge is hingably attached to the front cover inside face proximate the front cover outside edge to permit the secondary mirror to be rotated about the hinged attachment between a closed position and an open position, the closed position being defined as where the secondary mirror front surface rests against the front cover inside face, the open position being defined as where the secondary mirror front surface is rotated away from the front cover inside face to a desired second mirror angle; (f) a flexible protective material for covering the primary mirror, the flexible material having a top edge, bottom edge, right side edge and left side edge, the flexible material being attached to the back cover inside face to permit the protective material to cover the primary mirror when the mirror is not in use and to be pulled back to expose the mirror when the mirror is to be used, wherein one edge of the flexible protective material is mounted proximate to a corresponding edge of the primary mirror, wherein the flexible protective material is selected from the group consisting of: synthetic cloth, natural cloth, synthetic and natural cloth blends, plastic sheet material, rubber sheet material and the like; (g) one or more pockets located within the front cover inside face and/or the back cover inside face capable of receiving notepapers, sheet music, and the like; (h) one or more closure devices for securing the front cover to the back cover when the spine angle is either about 0° (where the front cover inside face faces the back cover inside face) and 360° (where the front cover outside face faces the back cover outside face), the closure devices being selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like; and (h) one or more attachment devices attachable proximate to the outer edges of the front cover outside edge and/or the back cover outside edge for securing the portfolio into a closed position or to secure the portfolio to a stand upon which the portfolio is placed, the one or more attachment devices being selected from the group consisting of ties, fasteners, hook and loop fasteners, straps, elastic loops, button fasteners, clips, and the like.

### BRIEF SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1A shows an embodiment of the mirrored portfolio in an open position with a left hinged mirror extended and a right fixed mirror exposed (cloth cover pulled back). A small pocket is shown on the left inside cover.

FIG. 1B shows a cross section of the right side cover of the portfolio of FIG. 1A taken along lines 1B-1B depicting an embodiment where the right fixed mirror is mounted on top of the surface of the right inside cover.

FIG. 1C shows a cross section of the right side cover of the portfolio of FIG. 1A taken along lines 1C-1C depicting another embodiment where the right fixed mirror is mounted recessed into the inside right cover.

FIG. 1D shows an embodiment of the mirrored practice notebook displayed in open position on a stand (depicted here in broken lines as, for example, a music stand).

FIG. 2A shows an embodiment of the mirrored portfolio in an open position with the left hinged mirror extension shown in the closed position (the back side of the left mirror is preferably non-reflective, but could be mirrored if desired). The right mirror is shown covered with a protective cover, such as a cloth. A small pocket is shown on the left inside cover.

FIG. 2B shows a cross section of the left side cover of the portfolio of FIG. 2A taken along lines 2B-2B in an embodiment where the left hinged mirror is mounted on the top surface of the left inside cover.

FIG. 2C shows a cross section of the left side cover of the portfolio of FIG. 2A taken along lines 2C-2C in an embodiment where the left hinged mirror is mounted recessed into the left inside cover.

FIG. 3 illustrates an embodiment of the mirrored practice notebook in an open position with the left hinged mirror extended and a hinged right mirror extended in a hinged configuration (cloth not shown). Pockets are shown on the left and right inside covers. Both mirrors are hinged along their respective outer edges to permit the mirrors to open outwardly.

FIG. 4 shows an embodiment of the mirrored portfolio in an open position with the left and right hinged mirrors in their closed positions. In this embodiment, the right mirror is hinged along its top edge to permit the mirror to swing upwardly. A large pocket is shown on the left inside cover.

FIG. 5A shows an embodiment of the mirrored portfolio in an open position with the left and right hinged mirrors in their closed positions. In this embodiment, the right mirror is hinged along its left edge along the inside spine of the portfolio, and is shown with a cloth cover over its surface. A large pocket is shown on the left inside cover.

FIG. 5B shows a perspective view from the back side of an embodiment of the notebook where the notebook is in a partially opened position.

FIG. 5C shows an embodiment of the notebook of FIG. 5A where the notebook is fully opened back on itself (outside cover to outside cover) displaying the large mirror (with its protective cover pulled back).

FIG. 5D illustrates an embodiment of the notebook of FIG. 5A shown in perspective view where the notebook is fully opened back on itself (outside cover to outside cover) displaying the large mirror (with the protective cover pulled back). This embodiment also illustrates that the angle of the mirror can be adjusted to suit the user.

FIG. 5E illustrates an embodiment of the notebook of FIG. 5A shown in perspective view where the notebook is fully opened back on itself (outside cover to outside cover) displaying the large mirror (with the cloth cover pulled back). The notebook is shown in use on a stand (depicted here in broken lines as, for example, a music stand). This embodiment also illustrates that the angle of the mirror can be adjusted to suit the user, particularly where the angle of the stand is not adjustable.

FIG. 6 illustrates an embodiment of the mirrored portfolio shown secured in a closed position.

It will be appreciated that the foregoing drawings illustrate only certain embodiments of the invention and that numerous other variations may be created within the scope of the described invention.

### DETAILED DESCRIPTION OF INVENTION

The above general description and the following detailed description are merely illustrative of the subject invention and additional modes, advantages and particulars of this invention will be readily suggested to those skilled in the art without departing from the spirit and scope of the invention.

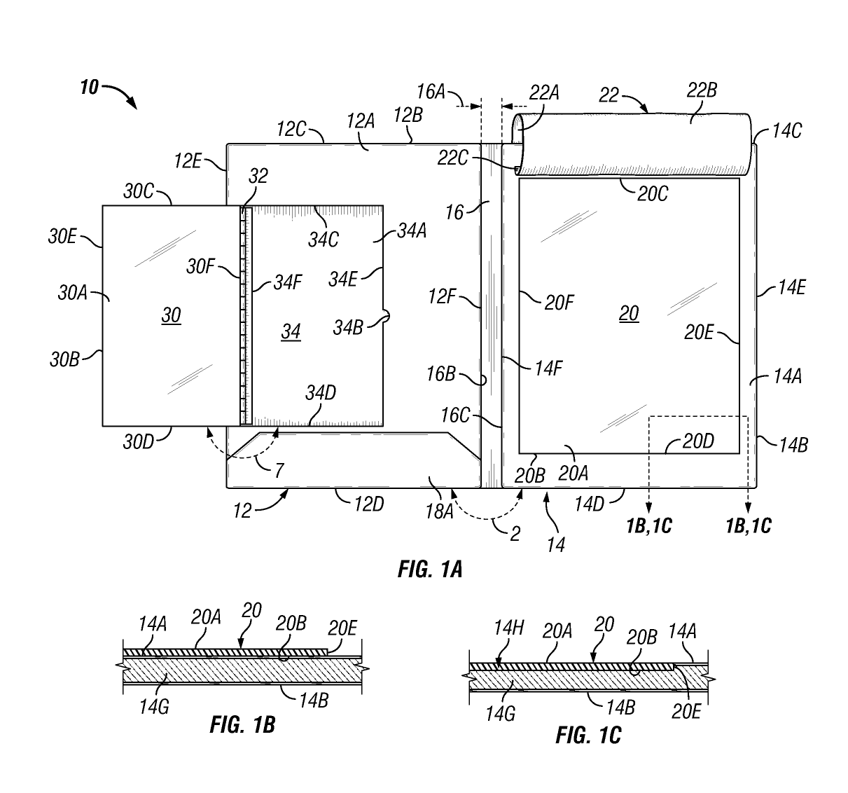

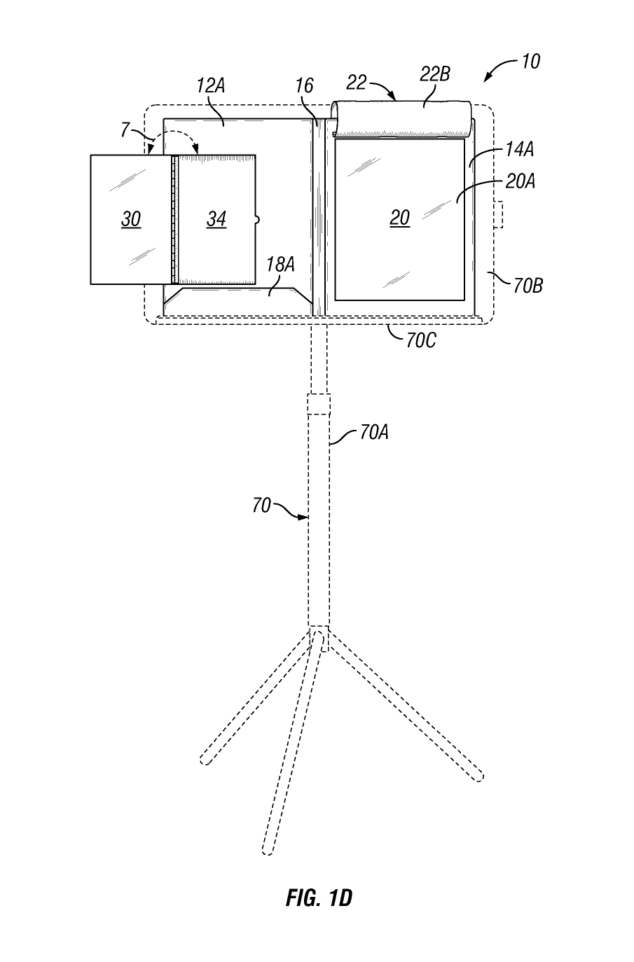

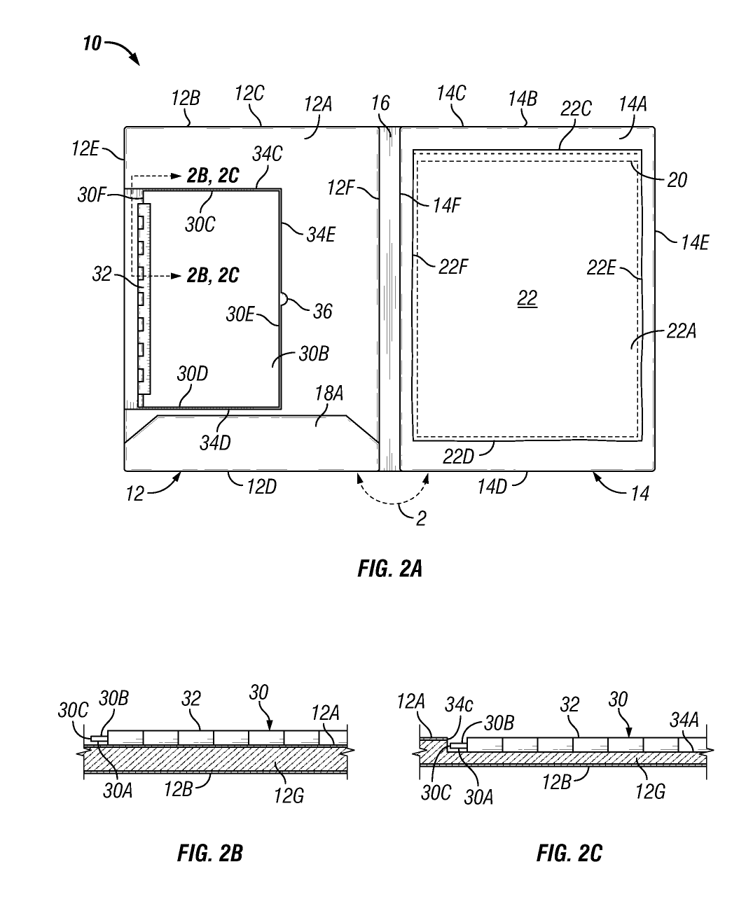

Referring now to FIGS. 1A-1D and 2A-2C there is depicted an embodiment of a mirrored portfolio or practice notebook 10 of the present disclosure shown in an open position with a left hinged mirror 30 in an extended, open position and a right mirror 20 in a fixed position with its mirrored surface 20a exposed. A protective cover 22 is shown pulled back. A small pocket 18a is shown on the left inside cover 12. More particularly, the mirrored portfolio or folder (or presentation folder) 10 of this embodiment comprises a front cover 12 having a front cover inside face 12a, a front cover outside face 12b, a front cover top edge 12c, a front cover bottom edge 12d opposite the front cover top edge 12c, a front cover outside edge 12e, and a front cover inside edge 12f opposite the front cover outside edge 12f. The mirrored portfolio or folder 10 of this embodiment also comprises a back cover 14 having an back cover inside face 14a, a back cover outside face 14b, a back cover top edge 14c, a back cover bottom edge 14d opposite the back cover top edge 14c, a back cover outside edge 14e, and a back cover inside edge 14f opposite the back cover outside edge 14e. A flexible spine or backbone section 16 hingedly connects or foldably joins the front cover inside edge 12f to the back cover inside edge 14f to permit the front cover 12 and back cover 14 to open and close about the hinged connection 16 along a desired spine angle 2.

In this embodiment, the mirrored portfolio 10 further comprises a first mirror 20 attached to the back cover inside face 14a, the first mirror 20 having a front surface 20a, a rear surface 20b, a top edge 20c, a bottom edge 20d opposite the top edge 20c, an inside edge 20f and an outside edge 20e opposite the inside edge. The mirrored portfolio 10 further comprises a second mirror 30 attached to the front cover inside face 12a, the second mirror 30 having a front surface 30a, a rear surface 30b, a top edge 30c, a bottom edge 30d opposite the top edge 30c, an inside edge 30f and an outside edge 30e opposite the inside edge 30f. In this embodiment, the second mirror inside edge 30f is hingably attached to the front cover inside face 12a proximate the front cover outside edge 12e to permit the second mirror 30 to be adjustably rotated about the hinged attachment 32 between a closed position (shown in FIG. 2A) and an open position (shown in FIG. 1A), the closed position being defined as where the second mirror front surface 30a rests against the front cover inside face 12a, the open position being defined as where the second mirror front surface 30a is rotated away from the front cover inside face 12a to a desired second mirror angle 7.

In preferred embodiments, one or more of the inside covers 12a, 14a contain a pocket 18a, 18b, 18c for holding papers, notes, sheet music, or other desired items and the like (see, e.g., FIGS. 1A, 2A, 3, 4, and 5A). The style of the pockets may be any of those known in the art of folios and notebooks, such as a two-sided simple flap 18b, 18c (attached along the lower and outside edges of the inside covers) or a three-sided open top pocket (attached along the lower, inside and outside edges of the inside covers) behind which the papers may be placed. In another embodiment, the pocket(s) may be an expandable or gusseted pocket. In one embodiment, at least one pocket is built into the front cover inside face. In another embodiment, at least one pocket is built into the back cover inside face. In yet another embodiment, the front and back cover each further comprise one or more pockets. Additionally, the front and/or back covers (inside or outside faces) may further comprise one or more pen/pencil holders and/or business card holder, or name card. Also, embodiments of the present invention may also include one or more external pockets.

In the embodiments depicted in FIGS. 1A-1D and 2A, the front surface or face 20a of the first mirror 20 contains or otherwise projects a reflective mirror finish (of any variety known in the art) and the rear surface 20b of the first mirror 20 is mounted to the back cover inside face 14a using glue, adhesives, double sided adhesive tape, fasteners, hook and loop fasteners, clips, mirror clips, J-shaped mirror clips, picture frame turn buttons, magnetic mounts, hinges or the like. As such, the mirror 20 may be permanently affixed, movably affixed, or removably affixed to the back cover inside face 14a. If the mirror 20 breaks, it can be replaced. The mirror 20 may be of any desired size and shape. In a preferred embodiment, the mirror 20 covers a substantial portion of the back cover inside face 14a such as illustrated in FIG. 1A. In another embodiment, the mirror 20 covers all or substantially all of the back cover inside face 14a. In one embodiment, the mirror 20 is mounted directly to the back cover inside face 14a such as illustrated in FIG. 1B. In another embodiment, as illustrated in FIG. 1C, the mirror 20 may also be mounted within a recessed area 14h of the back cover inside face 14a to permit the mirror 20 to be mounted flush with the back cover inside face 14a, or countersunk into the recessed area 14h. When the mirror 20 is mounted within the recessed area 14a, this helps to further protect the mirror and its edges.

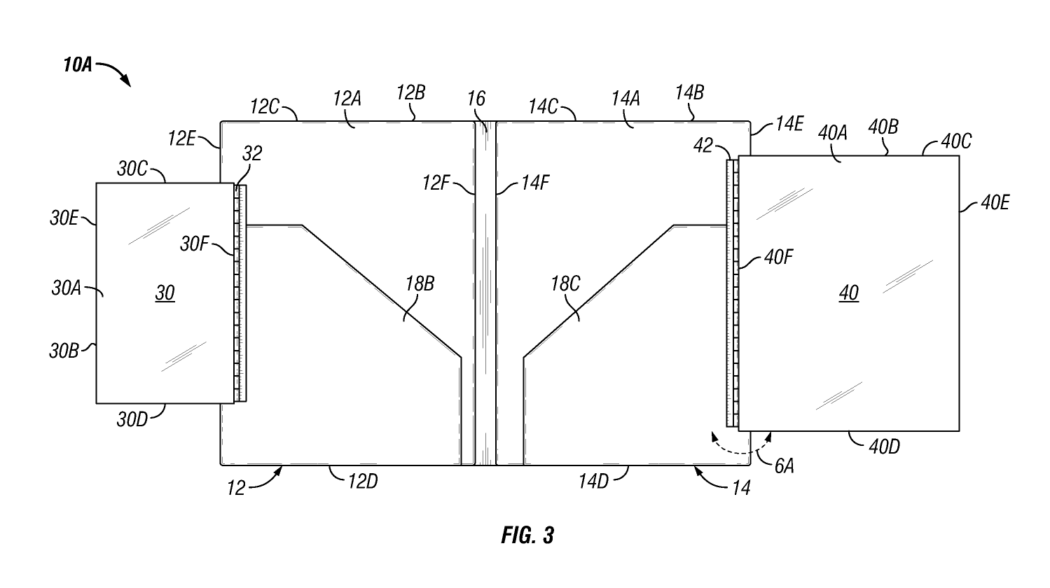

Referring now to FIGS. 3, 4, and 5A-5E, there are shown various representative arrangements illustrating how the first mirror 40, 50 or 60 may be hingably mounted to the back cover inside face 14a.

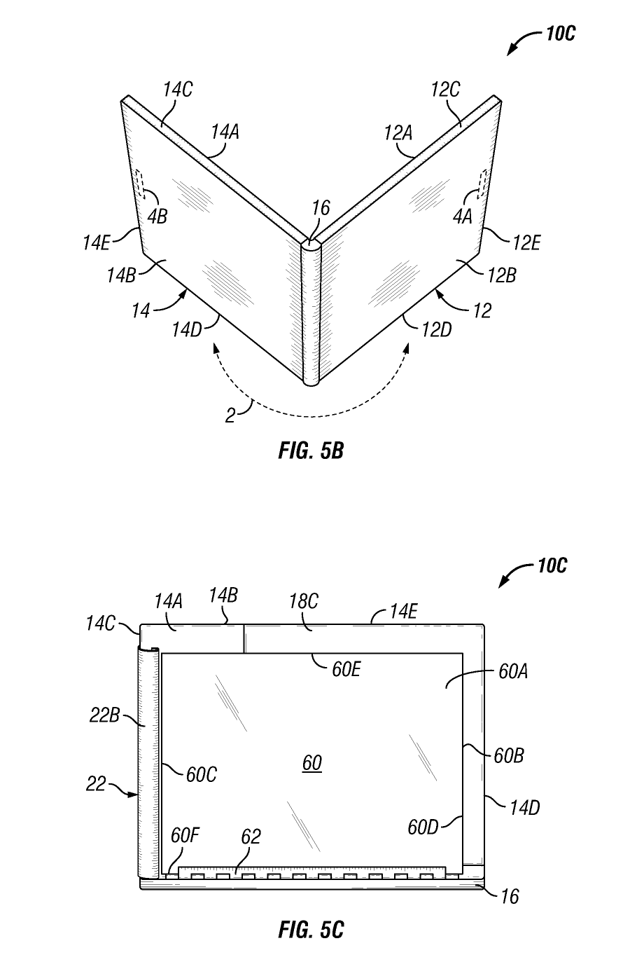

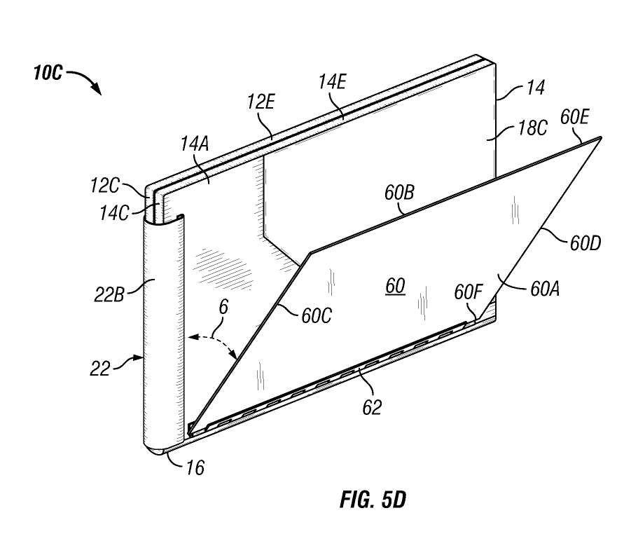

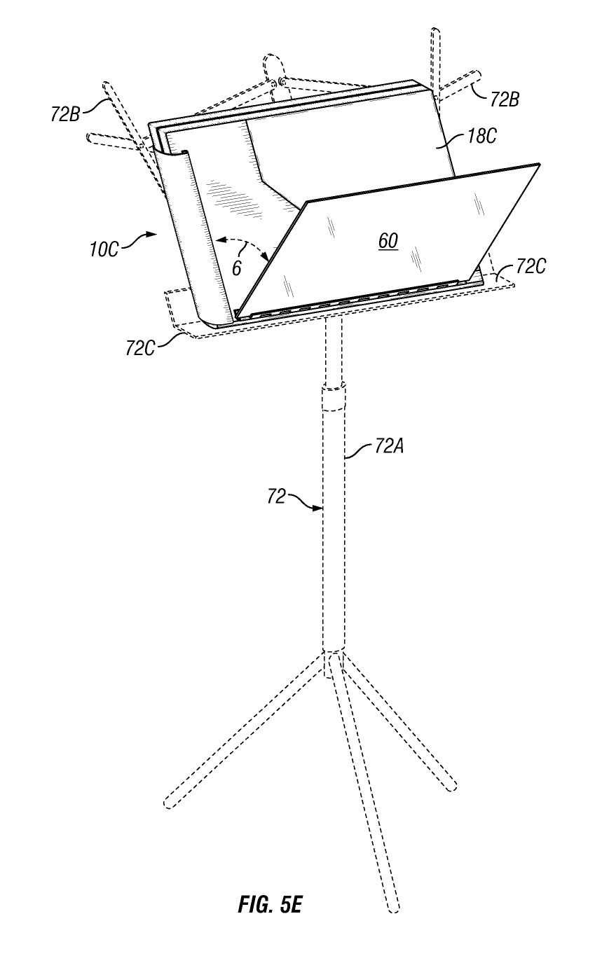

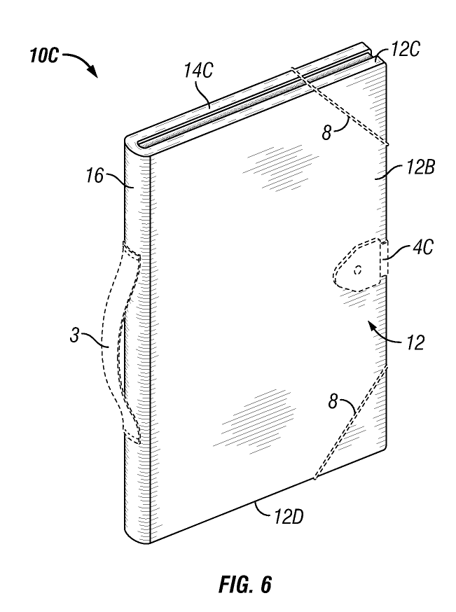

For example, FIGS. 5A, and 5C-5E show an embodiment wherein the first mirror 60 has a front surface 60a, a rear surface 60b, a top edge 60c, a bottom edge 60d opposite the top edge 60c, an inside edge 60f and an outside edge 60e opposite the inside edge. In this embodiment, the first mirror 60 inside edge 60f is hingably attached with a hinge device 62 to the back cover inside face 14a proximate the back cover inside edge 14f to permit the first mirror 60 to be rotated about its hinge 62 to a desired first mirror angle 6. In one embodiment, the front surface 60a of the first mirror 60 contains or otherwise projects a reflective mirror finish, i.e., the mirrored finish appears on the surface facing the user when the right (first) mirror 60 is rotated about its hinge 62 to its right-most position. In another embodiment, the rear surface 60b of the first mirror 60 contains or otherwise projects a reflective mirror finish, i.e., the mirrored finish appears on the surface facing the user when the right (first) mirror 60 is rotated about its hinge 62 to its left-most position. In yet another embodiment, both the front surface 60a and rear surface 60b of the first mirror 60 contain or otherwise project a mirrored finish so that a mirrored finish will face the user when the first mirror 60 is rotated about its hinge 62 to either its leftmost or rightmost position.

The first mirror 60 may be of any desired size and shape. In a preferred embodiment, the mirror 60 covers a substantial portion of the back cover inside face 14a such as illustrated in FIGS. 5A and 5C. In another embodiment, the mirror 60 covers all or substantially all of the back cover inside face 14a. In one embodiment, the hinge 62 for the mirror 60 is mounted directly to the back cover inside face 14a proximate to the back cover inside face 14a inside edge 14f. In another embodiment, the hinge 62 for the mirror 60 is mounted directly to the back cover inside face 14a along the back cover inside face 14a inside edge 14f such as illustrated in FIG. 1B. In another embodiment, the hinge 62 of the mirror 60 may be mounted to, or otherwise integrated into the spine or backbone 16 much like a leaf of the folio. In another embodiment, the mirror 60 may also be mounted within a recessed area 14h of the back cover inside face 14a to permit the mirror 60 to be mounted flush with the back cover inside face 14a, or countersunk into the recessed area 14h. When the mirror 60 is mounted within the recessed area 14a, this helps to further protect the mirror and its edges. In one embodiment, the first mirror angle 6 ranges between about 0° and 180° when the hinge 62 is mounted proximate the rear cover inside edge 14f. When the hinge 62 is mounted along the spine 16, and where the spine angle 2 ranges between about 0° and about 360° then the first mirror angle 6 may also range between about 0° and about 360°.

The first mirror may also be hingably connected to the folio in other configurations. For example, referring now to FIG. 3 there is illustrated an embodiment wherein the first mirror 40 has a front surface 40a, a rear surface 40b, a top edge 40c, a bottom edge 40d opposite the top edge 40c, an inside edge 40f and an outside edge 40e opposite the inside edge. In this embodiment, the first mirror 40 inside edge 40f is hingably attached with a hinge device 42 to the back cover inside face 14a proximate the back cover outside edge 14e to permit the first mirror 40 to be rotated about its hinge 42 to a desired first mirror angle 6a. In one embodiment, the front surface 40a of the first mirror 40 contains or otherwise projects a reflective mirror finish, i.e., the mirrored finish appears on the surface facing the user when the right (first) mirror 40 is rotated about its hinge 42 to a right-side (or open) position extending outward from the outer edge 14e. In another embodiment, the rear surface 40b of the first mirror 40 contains or otherwise projects a reflective mirror finish, i.e., the mirrored finish appears on the surface facing the user when the right (first) mirror 60 is rotated about its hinge 42 to its left-most (closed) position. In yet another embodiment, both the front surface 40a and rear surface 40b of the first mirror 40 contain or otherwise project a mirrored finish so that a mirrored finish will face the user when the first mirror 40 is rotated about its hinge 42 to either its leftmost or rightmost position.

The first mirror 40 may be of any desired size and shape. In a preferred embodiment, the mirror 40 covers a substantial portion of the back cover inside face 14a such as illustrated in FIG. 3. In another embodiment, the mirror 40 covers all or substantially all of the back cover inside face 14a. In one embodiment, the hinge 42 for the mirror 40 is mounted directly to the back cover inside face 14a proximate to the back cover inside face 14a outside edge 14e. In another embodiment, the hinge 42 for the mirror 40 is mounted directly to the back cover inside face 14a along the back cover inside face 14a outside edge 14e. In another embodiment, the hinge 42 of the mirror 40 may be mounted to, or otherwise integrated into the rear cover outer edge 14e. In another embodiment, the mirror 40 may also be mounted within a recessed area 14h of the back cover inside face 14a to permit the mirror 40 to be mounted flush with the back cover inside face 14a, or countersunk into the recessed area 14h. When the mirror 40 is mounted within the recessed area 14a, this helps to further protect the mirror and its edges. In one embodiment, the first mirror angle 6a ranges between about 0° and 180° when the hinge 42 is mounted proximate the rear cover outside edge 14e. When the hinge 42 is mounted along the outer edge 14e then the first mirror angle 6a may range between about 0° (where the mirror front surface 40a contacts the rear cover inside face 14a) and about 360° (where the mirror rear surface 40b contacts the rear cover outside face 14b).

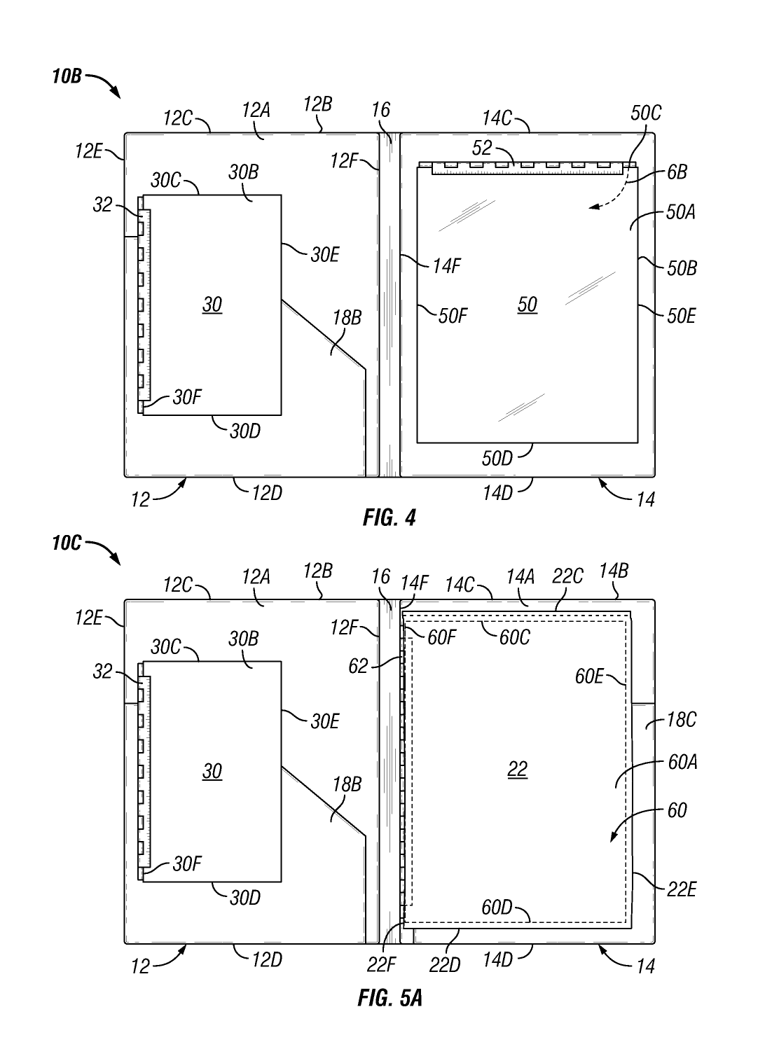

The first mirror may also be hingably connected to the folio in other configurations along either the top edge or bottom edge of the rear cover. For example, referring now to FIG. 4 there is illustrated an embodiment wherein the first mirror 50 has a front surface 50a, a rear surface 50b, a top edge 50c, a bottom edge 50d opposite the top edge 50c, an inside edge 50f and an outside edge 50e opposite the inside edge. In this embodiment, the first mirror 50 top edge 50c is hingably attached with a hinge device 52 to the back cover inside face 14a proximate the back cover top edge 14c to permit the first mirror 50 to be rotated about its hinge 52 to a desired first mirror angle 6b. In one embodiment, the front surface 50a of the first mirror 50 contains or otherwise projects a reflective mirror finish, i.e., the mirrored finish appears on the surface facing the user when the right (first) mirror 50 is in its closed position as shown in FIG. 4. In another embodiment, the rear surface 50b of the first mirror 50 contains or otherwise projects a reflective mirror finish, i.e., the mirrored finish appears on the surface facing the user when the right (first) mirror 50 is rotated upward about its hinge 52 to its up-most (open) position. In yet another embodiment, both the front surface 50a and rear surface 50b of the first mirror 50 contain or otherwise project a mirrored finish so that a mirrored finish will face the user when the first mirror 50 is rotated about its hinge 52 to either its closed or open positions.

The first mirror 50 may be of any desired type, size and shape. In a preferred embodiment, the mirror 50 covers a substantial portion of the back cover inside face 14a such as illustrated in FIG. 4. In another embodiment, the mirror 50 covers all or substantially all of the back cover inside face 14a. In one embodiment, the hinge 52 for the mirror 50 is mounted directly to the back cover inside face 14a proximate to the back cover inside face 14a top edge 14c. In another embodiment, the hinge 52 for the mirror 50 is mounted directly to the back cover inside face 14a along the back cover inside face 14a top edge 14c. In another embodiment, the hinge 52 of the mirror 50 may be mounted to, or otherwise integrated into the rear cover top edge 14c. In another embodiment, the mirror 50 may also be mounted within a recessed area 14h (like shown in FIG. 1C, for example) of the back cover inside face 14a to permit the mirror 50 to be mounted flush with the back cover inside face 14a, or countersunk into the recessed area 14h. When the mirror 50 is mounted within the recessed area 14a, this helps to further protect the mirror and its edges. In one embodiment, the first mirror angle 6b ranges between about 0° and 180° when the hinge 52 is mounted proximate the rear cover top edge 14c. When the hinge 52 is mounted along the top edge 14c then the first mirror angle 6b may range between about 0° (where the mirror rear surface 50b contacts the rear cover inside face 14a) and about 360° (where the mirror front surface 50a contacts the rear cover outside face 14b).

Referring now to FIGS. 1A, 1D, 2A-2C, 3, 4 and 5A, there is shown a representative arrangement illustrating how the second mirror 30 may be hingably mounted to the front cover inside face 12a. For example, the second mirror 30 has a front surface 30a, a rear surface 30b, a top edge 30c, a bottom edge 30d opposite the top edge 30c, an inside edge 30f and an outside edge 30e opposite the inside edge. In this embodiment, the second mirror 30 inside edge 30f is hingably attached with a hinge device 32 to the front cover inside face 12a proximate the front cover outside edge 12e to permit the second mirror 30 to be rotated about its hinge 32 to a desired second mirror angle 7. In one embodiment, the front surface 30a of the second mirror 30 contains or otherwise projects a reflective mirror finish, i.e., the mirrored finish appears on the surface facing the user when the left (second) mirror 30 is rotated about its hinge 32 to a left-side (or open) position extending outward from the outer edge 12e. In another embodiment, the rear surface 30b of the second mirror 30 contains or otherwise projects a reflective mirror finish, i.e., the mirrored finish appears on the surface facing the user when the left (second) mirror 30 is rotated about its hinge 32 to its right-most (closed) position. In yet another embodiment, both the front surface 30a and rear surface 30b of the second mirror 30 contain or otherwise project a mirrored finish so that a mirrored finish will face the user when the second mirror 30 is rotated about its hinge 32 to either its leftmost or rightmost position.

The mirror 30 may be of any desired type, size and shape. In a preferred embodiment, the mirror 30 covers approximately one-third to one-half of the front cover inside face 12a such as illustrated in FIG. 1A. In another embodiment, the mirror 30 covers a substantial portion of the front cover inside face 14a such as illustrated in FIG. 3. In yet another embodiment, the left mirror 30 is smaller than the right mirror 20. In another embodiment, the mirror 30 covers all or substantially all of the front cover inside face 12a. In one embodiment, the hinge 32 for the second mirror 30 is mounted directly to the front cover inside face 12a proximate to the front cover inside face 12a outside edge 12e. In another embodiment, the hinge 32 for the second mirror 30 is mounted directly to the front cover inside face 12a along the front cover inside face 12a outside edge 12e. In another embodiment, the hinge 32 of the second mirror 30 may be mounted to, or otherwise integrated into the front cover outer edge 12e. In another embodiment, the second mirror 30 may also be mounted within an optional recessed area 34 of the front cover inside face 12a to permit the second mirror 30 to be mounted flush with the front cover inside face 12a, or countersunk into the recessed area 34. The recessed area 34 has a bottom surface 34a, a tabbed cut-out 34b for opening left side mirror, a top edge 34c, a bottom edge 34d, an outside edge 34e and an inside edge 34f. When the second mirror 30 is mounted within the recessed area 12a, this helps to further protect the mirror and its edges. In one embodiment, the second mirror angle 7 ranges between about 0° and 180° when the hinge 32 is mounted proximate the front cover outside edge 12e. When the hinge 32 is mounted along the outer edge 12e then the second mirror angle 7 may range between about 0° (where the mirror front surface 30a contacts the front cover inside face 12a) and about 360° (where the mirror rear surface 30b contacts the front cover outside face 12b).

The mirrors used in the present invention are preferably constructed of a plastic material to minimize the potential for breakage or shattering, and to reduce the weight, but the mirror could be any suitable substrate capable of receiving a reflective coating. If a glass mirror is employed, it is preferred that it be a safety glass mirror having a special protective film on the back surface to prevent injuries in the event the mirror is broken. It is preferred that the mirrors used for the present invention be plane mirrors (those with flat reflective surfaces) so that they create virtual images of the same size as the original object. However, convex or concave mirrors could be used as may be desired. If desired, the one or more mirrors could be of a non-reversing mirror variety that provide a non-reversed image of its subject. The mirror(s) could be made from a plastic mirror sheet material, such as, e.g., mirrored acrylic, polystyrene, plexiglass, polycarbonate and the like such as those mirrored plastics offered by American Acrylics (www.americanacrylics.com), U.S. Plastics Corp. (www.usplastic.com) and Plaskolite, Inc. (Columbus, Ohio, www.plaskolite.com). For example, a ⅛-inch thick, or ¼-inch (or other thickness) acrylic or other plastic mirror could be cut to the desired size and shape for use in various embodiments disclosed herein of the first and second mirrors. Additionally, the plastic mirror could be double-sided (first surface/two-sided mirror) so that a mirrored/reflective surface is present on both sides of the mirror. Acrylic mirror sheets are the most popular lightweight and flexible mirror substrate available typically in the widest range of thicknesses. PETG mirror sheets are higher impact strength than acrylic and offers versatile fabrication properties with good impact strength, good design flexibility and speed of fabrication. PETG mirror is available in 0.030″-0.118″ in 48″×96″ sheets. The thinner PETG gauge sheet is ideal for the fabrication of children's toys, cosmetic uses and office supplies. Polycarbonate mirror sheets offer a very high impact strength. The optics of polycarbonate are comparable to acrylic, but its strength is 30 times stronger.

Because acrylic has a relatively soft surface and is flexible, some imperfections or distortions may occur in a mirrored acrylic mirror. Visual distortion is a function of viewing distance and material thickness. As such, according to websites plaskolite.com and theplasticshop.co.uk, depending on the size of the mirror, when using a plastic mirror material, a thicker mirror is preferred to maintain better optical integrity by reducing the possibility that the mirror could bend and distort the image. Mirrored acrylic is a reflective film applied to a substrate. As such, when the substrate is affixed to another surface, both of the materials will in time conform to the underlying supporting surface irregularities, thus, when mounting the mirror on the cover of the folio, it is preferred that the mounting surface of the cover be a smooth, rigid, sturdy flat backing. When using screws or other mechanical attachment to attach the mirror to the folio, care should be used to evenly tighten down the mirror to minimize distortion. When using a plastic mirror, where the mirror will be adhesively attached to the folio cover, the adhesive selected should be one that does not attack the backing material of the mirror. One such suitable adhesive is a chemically-curing, solvent free sealant and adhesive combining the best qualities of silicone and polyurethane sealants, such as the “Mirror Mate” mirror adhesive product sold by www.theplasticshop.co.uk. The mirrors may also be obtained with an adhesive backing that transfers an adhesive on the sheet once its protective paper layer is pulled off. An adhesive backed mirror has advantages over adhesives that are applied by hand that can cause messy edges and non-uniform adhesive coverage. Other suitable adhesives and mirror attachment devices are known in the art.

In another embodiment of the present invention, the mirrored folio further comprises a flexible protective material 22 for covering the first mirror, the flexible material having a topside outer surface 22a, an underside surface 22b, a top edge 22c, a bottom edge 22d, a right side edge 22e and a left side edge 22f, the flexible material 22 being attached to the back cover inside face 14a to permit the protective material 22 to cover the mirror (e.g., 20) (as shown in FIG. 2A) when the mirror is not in use and to be pulled back (as shown in FIG. 1A) to expose the mirror when the mirror is to be used, wherein the flexible protective material 22 may be selected from the group consisting of: synthetic cloth, natural cloth, flannel cloth, synthetic and natural cloth blends, soft suede-like material, plastic sheet material, rubber sheet material, and the like. The protective material may be mounted proximate the mirror in any number of ways, including, e.g., using adhesives, tape, sewing, and other fasteners, such as hook and loop fasteners. In the embodiment depicted in FIG. 1A and 2A, the protective cover 22 upper edge 22c is preferably mounted or attached proximate the mirror upper edge, e.g., 20c.

The hinges 32, 42, 52 and 62 described herein used to secure one or more mirrors to the folio covers preferably are friction hinges to permit the mirrors 30, 40, 50 and 60 to be rotated about their hinge angles and to hold the mirrors in the desired position. The hinge(s) may be a single hinge (continuous hinge), preferably extending substantially the entire length of the mirror edge, or otherwise extending a sufficient distance along the edge of the mirror to support the mirror. The hinge may also comprise one hinge, or a plurality of spaced-apart hinges. Various hinges known in the art can be employed in the present invention, including those selected from the group consisting of: metal, plastic, rubber or cloth hinges, inset hinges, overlay hinges, variable overlay hinges, torsion hinges, concealed hinges, semi-concealed hinges, non-mortise hinges, Soss hinges, Sepa hinges, barrel hinges, knife hinges, pin hinges, clip top hinges, back-to-back wrap around hinges, continuous hinges, slotted plano hinges, wrap around slotted plano hinges, partial wrap hinges, inset hinges, fully concealed hinges, tray table hinges, pivot hinges, roto hinges, stop hinges, butt hinges, specialty hinges, double action hinges, pivot hinges, single pin hinges, stop hinges, staple hasp catch hinges, Blum brand hinges, slide rail hinges, fixed pin hinges, spring hinges, box hinges, flush hinges, mortise hinges, parliament hinges, fastener hinges, friction hinges, strap hinges, tee hinges, finial tipped hinges, ball tipped hinges, and other metal hinges offered by, e.g., Rockier Woodworking and Hardware (Medina, Minn., www.rockler.com); www.houseofantiquehardware.com; and www.hardwaresource.com; for example. Different metals may be employed as are known in the art, such as, for example, brass, aluminum and stainless steel.

Additionally, plastic hinges, such as those made from flexible alloyed polymeric materials, modified polyolefin copolymers, or other plastics, acrylic, etc., may also be employed, such as, for example, the plastic pinless butt hinges and continuous hinges manufactured and sold by, e.g., C. E. Shepherd Company (Houston, Tex., www.ceshepherd.com). For example, these plastic hinges are advanced one-piece, molded, plastic, pinless hinges created for silent and maintenance-free service with never a need for lubrication. They will not fatigue or deteriorate even in wet or corrosive environments. Plastic hinges are available in continuous hinge style (similar to a plano hinge) or butt hinges in a range of standard sizes, and custom hinges can be molded to desired specifications. Other plastic hinges are available such as, for example, the acrylic hinges, plano hinges, polypropylene hinges, living hinges, and thermoplastic hinges (offset or flush) offered by U.S. Plastic Corp. (Lima, Ohio, www.usplastic.com) or the plastic hinges, plano hinges, butt hinges, and continuous hinges offered by Monroe Hinge & Stamping Co. (Auburn Hills, Mich., www.monroeengineering.com).

Also, cloth hinges could be used in the present invention to attach the mirrors to the folio. For example, glass cloth, fiberglass cloth, Kevlar brand cloth, or the cloth-bound hinges used on pressboard report covers, such as those made under the Universal brand, and other cloth hinge materials known in the art, including hinge tape materials, could be used.

Rubber (or other similar materials) or rubber gasket glass hinges could also be employed in creating a hinge for attaching one edge of a mirror to the folio similar to the glass-to-wall rubber hinges offered by Custom Hardware Manufacturing, Inc. (CHMI) (Keokuk, Iowa, www.chmi.com, and described in U.S. Pat. No. 5,687,869, incorporated herein by reference).

Additionally, other mechanisms for attaching the second mirror could be employed, including, a double retractable arm structure, a pivot arm structure, a telescoping structure and the like.

The covers 12 and 14 may be constructed as with any folio, presentation folder, music folder, diary, day planner and the like, and can be made from any number of materials known and used in the art including, without limitation, plastics, nylon, vinyl, leather, rawhide, leatherette, faux leather, pressboard, synthetic materials, paper/cardboard, cloth and the like. Exemplary folders may include an internal structural layers such as a pressboard panels that are in-turn covered by an outside covering of choice, e.g., vinyl, leather, leatherette, etc. The PlanAhead brand of folios may be modified according to the teachings of the present invention to include the features described herein. The covers 12, 14 may employ brass reinforced corners (not shown). The size of the folio (outside dimensions) can vary according to the desired use. Also, Company Folders, Inc. (Keego Harbor, Mich., www.companyfolders.com) offers a wide variety of folders, binders, portfolios, presentation folders and the like that could be suitably outfitted with the mirrors according to the teachings herein to form a mirrored portfolio embodiments of the present invention. Additionally, Levenger Company (Delray Beach, Fla., www.levenger.com) carries a line of folios that could also be modified according to the teachings of the present disclosure to become mirrored portfolios of the present invention.

The zippered style day planners described by White, U.S. Pat. No. 6,017,062 (which is incorporated herein by reference in its entirety for all purposes), and offered by The Mead Corporation, Dayton, Ohio, could also serve as an exemplary structure to modify according the present teachings to create a zippered, mirrored portfolio. In this case, where the planner is a ring binder style, the first mirror could be mounted on the inside back cover, or could be mounted on a page/leaf structure that could be hole-punched and inserted into the ring binder Likewise, the second mirror could be hingably mounted on the inside front cover of the planner, or could be hingably mounted to a page/leaf that can be inserted into the ring binder.

The mirrored portfolio or presentation folder/notebook may further comprise one or more closure devices or fasteners 4a, 4b, 4c, 8, for securing the front cover to the back cover when the spine angle is either about 0° (where the front cover inside face faces the back cover inside face) and 360° (where the front cover outside face faces the back cover outside face), the closure devices being selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like and other closure devices used on folios and notebooks as are known in the art (e.g., as shown in White, U.S. Pat. No. 6,017,062. The folio may also employ an external strap or handle 3 as may be desired.

Also, the folio may also be equipped with one or more attachment devices (e.g., 8) for securing the portfolio practice mirror to a stand, the one or more attachment devices being selected from the group consisting of ties, fasteners, hook and loop fasteners, straps, elastic loops, button fasteners, and clips.

For example, music folders often are oversized (e.g., about 12 inches wide and 15 inches tall) compared with standard letter-size note folios. Exemplary custom leather music folders, such as the Pollock Leather Music Folder (www.stephen-pollock.com) could be outfitted with the mirrors according to the teachings herein to form a mirrored music folder embodiment of the present invention.

Similarly, standard or padded music folders could also be modified according to the present teachings to create mirrored music folder embodiments of the present invention. For example, “The Black Folder” is a popular, lightweight, ergonomic choral music folder measuring 10¾ inches by 12½ inches, available from, e.g., The Music Mart, Inc. (Albuquerque, N. Mex. www.musicmart.com), and Small World Musicfolder.com Inc. (Vancouver, BC, www.musicfolder.com). This folder is a strong, heavy-duty construction with leatherette exterior (and interior pockets) for long durability. This folder employs a retainer strap on its interior bottom to prevent loose music from sliding out, and can also be used to holds the folder open. This folder also features a button on the folder to unsnap the bottom strap to open the folder wider. The folder also employs 10 elastic cords installed in an aluminum hinge to holds music in place for complete security. A separate ring binder, which can be threaded into the strings, can be added to the folder. The folder uses sewn edges (double-sewn on top and bottom), a heavy weight hand strap, and brass corners. This folder is also provided with two gusseted pockets with ½″ of expansion. Where the mirrored folio of the present invention is used by a person standing and holding the folder (e.g., a choral singer, a presenter, etc.) it is preferred that the mirrors be lightweight plastic material. Similar band and orchestra music folders are available and can be modified according to the present teachings herein to construct mirrored folio embodiments of the present invention from sources such as www.hickeys.com, www.protecmusic.com (padded music folders).

In one embodiment (depicted generally in the cross-sectional views FIGS. 1B, 1C, 2B and 2C), the back cover 14 and/or front cover 12 (not shown) may further comprise a layer of padding, e.g., 14g (shown on back cover) and 12g (shown on the front cover). As such, as may be desired for aesthetics and/or to better protect the contents of the mirrored portfolio (including the mirror(s), a padded layer 12g may be employed between the front cover inside face 12a and the front cover outside face 12b and/or a padded layer 14g may be employed between the back cover inside face 14a and the back cover outside face 14b. The padding material may be any suitable padding material, such as those padding materials used in existing padded folios, padded presentation folders, padded music folders, etc. and those selected from the group consisting of: foam, neoprene, quilt batting, felt, sueded polyethylene, polyester padding, air cell padding, and the like as are known in the art of folios.

The spine or backbone 16 may be constructed in any number of ways, and have varying spine widths 16a. For example, in one embodiment, the spine 16, front cover 12 and back cover 14 may be formed from the same sheet of material. In another embodiment, the flexible spine or backbone 16 is simply formed by the joining together of front cover inside edge 12f to back cover inside edge 14f. In one embodiment, the front cover 12 and back cover 14 are formed from a contiguous material, and the spine 16 is simply the vertical midpoint between the front cover outside edge 12e and the back cover outside edge 14e. In yet another embodiment, the spine 16 is formed by creating a fold or crease at the juncture of the front cover inside edge 12f to the back cover inside edge 14f. As will be understood, the width 16a of the spine 16 can be varied according to the desired volume of materials (sheet capacity) to be contained inside of the mirrored portfolio 10. In another embodiment, the spine 16 is a substantially flat or partially curved, rigid surface having a left edge 16b that is attached (via flexible or hinged attachment) to the front cover inside edge 12f and a right edge 16c that is attached (via flexible or hinged attachment) to the back cover inside edge 14f. In other embodiments, the spine 16 may be a hinge (as described herein or otherwise known in the art), a flexible material, a ring binder ringed notebook spine, a locking slant-D or round ring binder spine, a zippered binder spine, a presentation folder backbone, a folder single-score backbone, a folder double-score backbone, a folder triple-score backbone a velo-bound spine, a spiral bound spine, a twin loop wire binding, a comb binding, a ring binding, tape binding, saddle stitch binding, perfect binding, stapled binding, a music folder spine, a book bindery spine, and the like.

The folio embodiments employing a hinged primary mirror may also be modified to create a storage area in the inside back cover 14a for storing papers, pencils, etc. The mirror would serve as a hinged covering for this storage area.

In a preferred embodiment, the spine angle 2 is adjustable between about 0° (where the front cover inside face 12a faces, or touches, or is substantially parallel with the back cover inside face 14a) and about 360° (where the front cover outside face 12b faces, or touches or is substantially parallel with the back cover outside face 14b). The spine 16 can also be constructed as with the spines of typical folios, portfolios, padfolios, presentation folders, diaries, and the like.

Referring now to FIGS. 1D and 5E, there are disclosed examples of how two of the mirrored portfolio embodiments described herein might be used. In FIG. 1D, the folio 10 can be placed on a stand (such as a music stand 70 having a base section 70a, a vertical support section 72b, and a horizontal ledge section 70c extending outward from the lower edge of the vertical support section 72. In this embodiment, the folio 10 is opened much like a book, and is placed on the music stand 70 (or plano music ledge, speaker's podium, or is held by hand, etc.). The cover 22 is pulled back from the first (primary) mirror 20 to expose the reflective surface 20a so that the user may observe himself/herself while practicing or actually performing/presenting. As may be desired, the second (secondary) mirror 30 may be opened to a desired mirror angle 7 to provide an extended mirrored view. The folio may be equipped with straps, elastic or other attachment devices 8 to help secure the folio 10 to the stand 70b. In FIG. 5E (and also referring to FIGS. 5A-5D), the folio 10c is displayed on a music stand 72 having a base, 72a, a vertical support section 72b and a horizontal ledge section 72c extending outwardly from the vertical support section 72b. The folio 10c is opened back on itself so that the outsides of covers 14 and 12 touch each other, and may be secured to each other via fasteners 4a, 4b. The spine 16 of the folio 10c is placed on the music stand ledge 72c or other surface (e.g., podium, plano), and the primary mirror 60 (or 20 from FIG. 1D) faces the user. If the secondary mirror is hingedly attached to the folio 10c, as in FIG. 5E, the user may adjust the angle 6 of the primary mirror as may be desired. The angle adjustment can be useful particularly where the music stand (or podium or plano) is a fixed (non adjustable) angle. When finished, the user may store papers in the one or more pockets of the folio. The folio can then be closed, and if desired, fasteners may be used to keep the folio closed during storage or transport. The folio may have a carrying strap 3 attached. The configuration shown in FIG. 1D is particularly advantageous for use with a musician using longer instruments, such as a violin or guitar.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention. Further modifications and alternative embodiments of this invention will be apparent to those skilled in the art in view of this specification.

I claim:

1. A portable mirrored practice notebook comprising:
a. a front cover having a front cover inside face, a front cover outside face, a front cover top edge, a front cover bottom edge opposite the front cover top edge, a front cover outside edge, and a front cover inside edge opposite the front cover outside edge;
b. a back cover having a back cover inside face, a back cover outside face, a back cover top edge, a back cover bottom edge opposite the back cover top edge, a back cover outside edge, and a back cover inside edge opposite the back cover outside edge;
c. a flexible spine hingedly connecting the front cover inside edge to the back cover inside edge to permit the front cover and back cover to open and close about the hinged connection along a desired spine angle;
d. a first mirror attached to the back cover inside face, the first mirror having a front surface, a rear surface, a top edge, a bottom edge opposite the top edge, an inside edge and an outside edge opposite the inside edge;
e. a second mirror attached to the front cover inside face, the second mirror having a front surface, a rear surface, a top edge, a bottom edge opposite the top edge, an inside edge and an outside edge opposite the inside edge, wherein the second mirror inside edge is hingably attached to the front cover inside face proximate the front cover outside edge to permit the second mirror to be adjustably rotated about the hinged attachment between a closed position and an open position, the closed position being defined as where the second mirror front surface rests against the front cover inside face, the open position being defined as where the second mirror front surface is rotated away from the front cover inside face to a desired second mirror angle; and
f. at least one pocket to receive notepapers, sheet music, or the like.

2. The notebook of claim 1 wherein the front surface of the first mirror contains a reflective mirror finish and the rear surface of the first mirror is mounted to the back cover inside face using glue, adhesives, double sided adhesive tape, clips, fasteners, hook and loop fasteners, magnetic mounts, hinges or the like.

3. The notebook of claim 1 wherein the first mirror inside edge is hingably attached to the back cover inside face proximate the back cover inside edge to permit the first mirror to be rotated about its hinge.

4. The notebook of claim 3 wherein the front surface of the first mirror contains a reflective mirror finish.

5. The notebook of claim 3 wherein the rear surface of the first mirror contains a reflective mirror finish.

6. The notebook of claim 3 wherein the front surface and rear surface of the first mirror contain a reflective mirror finish.

7. The notebook of claim 1 wherein the first mirror outside edge is hingably attached to the back cover inside face proximate the back cover outside edge to permit the first mirror to be rotated about its hinge.

8. The notebook of claim 7 wherein the front surface of the first mirror contains a reflective mirror finish.

9. The notebook of claim 7 wherein the rear surface of the first mirror contains a reflective mirror finish.

10. The notebook of claim 7 wherein the rear surface of the first mirror contains a reflective mirror finish.

11. The notebook of claim 1 wherein the first mirror top edge is hingably attached to the back cover inside face proximate the back cover top edge to permit the first mirror to be rotated about its hinge.

12. The notebook of claim 11 wherein the front surface of the first mirror contains a reflective mirror finish.

13. The notebook of claim 11 wherein the rear surface of the first mirror contains a reflective mirror finish.

14. The notebook of claim 11 wherein the rear surface of the first mirror contains a reflective mirror finish.

15. The notebook of claim 1 wherein the back cover inside face further comprises a recessed area for receiving the first mirror.

16. The notebook of claim 1 wherein the first mirror covers a substantial portion of the back cover inside face.

17. The notebook of claim 1 further comprising a flexible protective material for covering the first mirror, the flexible material having a top edge, bottom edge, right side edge and left side edge, the flexible material being attached to the back cover inside face to permit the protective material to cover the mirror when the mirror is not in use and to be pulled back to expose the mirror when the mirror is to be used, wherein the flexible protective material is selected from the group consisting of: synthetic cloth, natural cloth, flannel cloth, synthetic and natural cloth blends, soft suede-like material, plastic sheet material, rubber sheet material, and the like.

18. The notebook of claim 17 wherein the top edge of the flexible protective material is mounted proximate to the first mirror upper edge.

19. The notebook of claim 1 wherein the second mirror angle ranges between about 0° and 180°.

20. The notebook of claim 1 wherein the second mirror front surface contains a reflective mirror finish.

21. The notebook of claim 1 wherein the second mirror rear surface contains a reflective mirror finish.

22. The notebook of claim 1 wherein the second mirror front surface and back surface contain a reflective mirror finish.

23. The notebook of claim 1 wherein the front cover inside face further comprises a recessed area for receiving the second mirror when the second mirror is in its closed position.

24. The notebook of claim 1 further comprising a padded layer between the front cover inside face and the front cover outside face and a padded layer between the back cover inside face and the back cover outside face.

25. The notebook of claim 1 wherein the spine angle is adjustable between about 0° and about 360°.

26. The notebook of claim 1 wherein the at least one pocket is built into the front cover inside face.

27. The notebook of claim 1 wherein the at least one pocket is built into the back cover inside face.

28. The notebook of claim 1 further comprising one or more closure devices for securing the front cover to the back cover when the spine angle is either about 0° (where the front cover inside face faces the back cover inside face) and 360° (where the front cover outside face faces the back cover outside face), the closure devices being selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like.

29. The notebook of claim 1 further comprising one or more attachment devices for securing the portfolio practice mirror to a stand, the one or more attachment devices being selected from the group consisting of ties, fasteners, hook and loop fasteners, straps, elastic loops, button fasteners, clips and the like.

30. A portable mirrored practice portfolio comprising:
a. a padded front cover having an front cover inside face, a front cover outside face, a front cover top edge, a front cover bottom edge opposite the front cover top edge, a front cover outside edge, and a front cover inside edge opposite the front cover outside edge;
b. a padded back cover having an back cover inside face, a back cover outside face, a back cover top edge, a back cover bottom edge opposite the back cover top edge, a back cover outside edge, and a back cover inside edge opposite the back cover outside edge;
c. a flexible spine hingedly connecting the front cover inside edge to the back cover inside edge to permit the front cover and back cover to open and close about the hinged connection along a desired spine angle;
d. a first mirror fixedly attached to the back cover inside face, the first mirror having a front mirrored finish surface, a rear surface attached to the back cover inside face, a top edge, a bottom edge opposite the top edge, an inside edge and an outside edge opposite the inside edge, wherein the rear surface of the first mirror is attached to the back cover inside face using glue, adhesives, double sided adhesive tape, clips, fasteners, hook and loop fasteners, magnetic mounts, hinges or the like;
e. a second mirror attached to the front cover inside face, the second mirror having a front mirrored finish surface, a rear surface, a top edge, a bottom edge opposite the top edge, an inside edge and an outside edge opposite the inside edge, wherein the second mirror inside edge is hingably attached to the front cover inside face proximate the front cover outside edge to permit the second mirror to be rotated about the hinged attachment between a closed position and an open position, the closed position being defined as where the second mirror front surface rests against the front cover inside face, the open position being defined as where the second mirror front surface is rotated away from the front cover inside face to a desired second mirror angle;
f. a flexible protective material for covering the first mirror, the flexible material having a top edge, bottom edge, right side edge and left side edge, the flexible material being attached to the back cover inside face to permit the protective material to cover the mirror when the mirror is not in use and to be pulled back to expose the mirror when the mirror is to be used, wherein one edge of the flexible protective material is mounted proximate to a corresponding edge of the first mirror, wherein the flexible protective material is selected from the group consisting of: synthetic cloth, natural cloth, synthetic and natural cloth blends, plastic sheet material, rubber sheet material and the like;
g. one or more pockets located within the front cover inside face and/or the back cover inside face capable of receiving notepapers, sheet music, and the like; and
h. one or more elastic loops attachable proximate to the outer edges of the front cover outside edge and/or the back cover outside edge for securing the portfolio into a closed position or to secure the portfolio to a stand upon which the portfolio is placed.

31. A portable mirrored practice folio comprising:
a. a front cover having an front cover inside face, a front cover outside face, a front cover top edge, a front cover bottom edge opposite the front cover top edge, a front cover outside edge, and a front cover inside edge opposite the front cover outside edge;
b. a back cover having an back cover inside face, a back cover outside face, a back cover top edge, a back cover bottom edge opposite the back cover top edge, a back cover outside edge, and a back cover inside edge opposite the back cover outside edge;
c. a flexible spine hingedly connecting the front cover inside edge to the back cover inside edge to permit the front cover and back cover to open and close about the hinged connection along a desired spine angle;
d. a primary mirror fixedly attached to the back cover inside face, the primary mirror having a front mirrored finish surface, a rear surface, a top edge, a bottom edge opposite the top edge, an inside edge and an outside edge opposite the inside edge, wherein the primary mirror inside edge is hingably attached to the back cover inside face proximate the back cover inside edge to permit the primary mirror to be rotated about its hinge;
e. a secondary mirror attached to the front cover inside face, the secondary mirror having a front mirrored finish surface, a rear surface, a top edge, a bottom edge opposite the top edge, an inside edge and an outside edge opposite the inside edge, wherein the second mirror inside edge is hingably attached to the front cover inside face proximate the front cover outside edge to permit the secondary mirror to be rotated about the hinged attachment between a closed position and an open position, the closed position being defined as where the secondary mirror front surface rests against the front cover inside face, the open position being defined as where the secondary mirror front surface is rotated away from the front cover inside face to a desired second mirror angle;
f. a flexible protective material for covering the primary mirror, the flexible material having a top edge, bottom edge, right side edge and left side edge, the flexible material being attached to the back cover inside face to permit the protective material to cover the primary mirror when the mirror is not in use and to be pulled back to expose the mirror when the mirror is to be used, wherein one edge of the flexible protective material is mounted proximate to a corresponding edge of the primary mirror, wherein the flexible protective material is selected from the group consisting of: synthetic cloth, natural cloth, synthetic and natural cloth blends, plastic sheet material, rubber sheet material and the like;
g. one or more pockets located within the front cover inside face and/or the back cover inside face capable of receiving notepapers, sheet music, and the like;
h. one or more closure devices for securing the front cover to the back cover when the spine angle is either about 0° (where the front cover inside face faces the back cover inside face) and 360° (where the front cover outside face faces the back cover outside face), the closure devices being selected from the group consisting of hook and loop fasteners, clasp closures, snap closures, magnet closures, ties, ribbons, straps, elastic loops, elastic ties, buttons, zippers, belt with fastener, buckles, loop and belt strap enclosures, belt and buckle enclosures, belt and snap enclosures, and the like; and
i. one or more attachment devices attachable proximate to the outer edges of the front cover outside edge and/or the back cover outside edge for securing the portfolio into a closed position or to secure the portfolio to a stand upon which the portfolio is placed, the one or more attachment devices being selected from the group consisting of ties, fasteners, hook and loop fasteners, straps, elastic loops, button fasteners, clips, and the like.
